(19) United States
(12) Patent Application Publication
(10) Pub. No.: US 2015/0029981 A1
(43) Pub. Date: Jan. 29, 2015

(54) MOBILE STATION DEVICE, BASE STATION DEVICE, WIRELESS COMMUNICATION SYSTEM AND TRANSMISSION METHOD

(71) Applicant: Sharp Kabushiki Kaisha, Osaka-shi, Osaka (JP)

(72) Inventors: Hiroki Takahashi, Osaka-shi (JP); Jungo Goto, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: Sharp Kabushiki Kaisha, Osaka-shi, Osaka (JP)

(21) Appl. No.: 14/385,812

(22) PCT Filed: Mar. 15, 2013
(86) PCT No.: PCT/JP2013/057382

§ 371 Date: Sep. 17, 2014

(30) Foreign Application Priority Data
Mar. 30, 2012 (JP) 2012-082033

(51) Int. Cl. H04W 74/08; H04W 72/12

(52) U.S. Cl. CPC H04W 74/08; H04W 72/1278
USPC 370/329

(57) ABSTRACT

A probability of collision when a plurality of mobile station devices use contention based (CB) transmission is reduced. Provided is a mobile station device which performs the CB transmission, based on a control signal received from a base station device. The mobile station device includes a control information extraction unit 105 that extracts the control signal for CB transmission from the control information; a clipping unit 107 that generates a partial spectrum by removing a portion of a spectrum, from a spectrum of a transmit signal, based on the extracted control information for CB transmission; and a transmission unit 125 that transmits a signal with the partial spectrum to the base station device.

### TECHNICAL FIELD

The present invention relates to a wireless communication technology using a contention based (CB) transmission.

### BACKGROUND ART

In recent years, LTE-Advanced (LTE-A) which has been further developed from a long term evolution (LTE) system which is a wireless communication system of a mobile phone of the 3.9 generation has been standardized as one of the wireless communication systems of the fourth generation (also referred to as IMT-A or the like). As described in Non Patent Literature 1, in LTE-A, in addition to contention free (CF) transmission in which transmission is performed while a radio resource is allocated so as to avoid collision with another mobile station device in a cell, contention based (CB) transmission has been proposed in which the time taken for the exchange of control information up to the start of communication may be reduced by not performing control for avoiding collision with another mobile station device in a cell. Hereinafter, the CF transmission and the CB transmission will be described.

In the CF transmission used in the LTE system or the like, a mobile station device sends notification of a request referred to as scheduling request (SR) to a base station device before data transmission. The base station device which has received the SR allocates a transmission band to the mobile station device which is a destination and has a cell-radio network temporary identity (C-RNTI), and notifies the allocation information, modulation and coding schemes (MCS) to be used in transmission, and the like as a scheduling grant (SG). Thereafter, the mobile station device which has received the SG generates a data signal from the allocated band and control information required for generating a transmit signal such as MCS, and starts transmission to the base station device. By taking such a procedure, the mobile station device is able to perform stable communication by using a band allocated thereto regardless of the absence or presence of transmission of another mobile station device in the cell.

However, since the CF transmission which takes the procedure described above requires the transmission and reception of the control information between the mobile station device and the base station device up to the start of the transmission of data, there is a problem of taking a lot of time. With respect to such a problem, it is possible to reduce the time required up to the start of transmission in the CB transmission. Specifically, when at least a portion of the frequency resources in a cell is unoccupied due to some conditions or is secured as a band for CB transmission, without limiting a destination to one mobile station device, the base station device takes a group of mobile station devices capable of performing the CB transmission (also referred to as contention based-radio network temporary identity (CB-RNTI)) in the cell, as destinations and notifies the group of mobile station devices that the CB transmission is possible. In addition, after the notification, the base station device transmits the MCS for performing the CB transmission by any mobile station device using a free band and control information indicating the allocated band as the CB grant to the destination described above. The mobile station device that transmits data by the CB transmission monitors whether there is the notification for the destination described above, and when there is the notification, the mobile station device demodulates the CB grant. Then, the mobile station device generates a data signal using the received CB grant and starts transmission to the base station device. In this manner, in the CB transmission, the mobile station device is not transmit SR as in the CF transmission, and there is no waiting time until the band is allocated, thus there is an advantage of being capable of accelerating the start of transmission.

### CITATION LIST

### Non Patent Literature

NPL 1: 3GPP, R2-093812

### SUMMARY OF INVENTION

### Technical Problem

However, when there are a lot of mobile station devices that perform the CB transmission, a CB grant is transmitted to one or more mobile station devices capable of performing the CB transmission, and therefore there is a possibility that a plurality of mobile station devices simultaneously start the transmission using the same radio resource. In this case, the signals which are simultaneously transmitted from the mobile station devices interfere with each other, and thus the transmission performances are degraded. If such a case is defined that a plurality of mobile station devices “collide”, some transmission failures due to collision occur in the CB transmission, and as a result, there is a problem that transmission throughput is reduced.

The present invention is made in view of the problems, and an object thereof is to provide a mobile station device, a base station device, a wireless communication system, and a transmission method, which are able to reduce the probability of collision when a plurality of mobile station devices use the CB transmission.

### Solution to Problem

(1) In order to achieve the above object, the present invention includes the following means. In other words, a mobile station device of the present invention is a mobile station device which performs contention based (CB) transmission, based on a control signal received from a base station device, and includes a control information extraction unit that extracts a control signal for CB transmission from the control information; a clipping unit that generates a partial spectrum by removing a portion of spectrum, from a spectrum of a transmit signal, based on the extracted control information for CB transmission; and a transmission unit that transmits a signal with the partial spectrum to the base station device.

In this manner, since the portion of the spectrum among the spectra of the transmit signal is removed, and a partial spectrum is generated, as the allocated band per CB transmission is narrowed, the number of candidates for the allocated band for the CB transmission increases, and thus it is possible to reduce the collision probability. As a result, it becomes possible to improve the transmission efficiency in the CB transmission.

(2) Further, in the mobile station device of the present invention, the clipping unit removes a predetermined portion of the spectrum, from a spectrum of the transmit signal.

In this manner, since a predetermined portion of the spectrum is removed from a spectrum of the transmit signal, as the allocated band per CB transmission is narrowed, the number of the candidates for the allocated band for the CB transmission increases, and thus it is possible to reduce the collision probability. As a result, it becomes possible to improve the transmission efficiency in the CB transmission.

(3) Further, in the mobile station device of the present invention, the clipping selects a candidate spectrum among a plurality of candidate spectra which are predetermined as the portion of spectrum to be removed.

In this manner, since a candidate spectrum is selected among the plurality of candidate spectra which are predetermined as a portion of the spectrum to be removed, even when a plurality of mobile station devices use the same control information for CB transmission, it is possible to reduce the collision probability, and as a result, it becomes possible to improve the transmission efficiency in the CB transmission.

(4) Further, in the mobile station device of the present invention, the clipping unit selects a candidate spectrum with a high frequency or a candidate spectrum with a low frequency.

In this manner, since the candidate spectrum with a high frequency or the candidate spectrum with a low frequency is selected, even when a plurality of mobile station devices use the same control information for CB transmission, it is possible to reduce the collision probability, and as a result, it becomes possible to improve the transmission efficiency in the CB transmission.

(5) Further, in the mobile station device of the present invention, the clipping unit determines a portion of spectrum to be removed, based on identification information by which the base station device identifies the mobile station device.

In this manner, since a portion of spectrum to be removed is determined, based on the identification information by which the base station device identifies the mobile station device, even when a plurality of mobile station devices use the same control information for CB transmission, it is possible to reduce the collision probability, and as a result, it becomes possible to improve the transmission efficiency in the CB transmission.

(6) Further, the mobile station device of the present invention further includes a transmission power control unit that corrects transmission power of a transmit signal, by using a certain correction value that is configured for each mobile station device by the base station device, in which a transmit signal of which transmission power is corrected is transmitted to the base station device.

In this manner, since the transmit signal of which the transmission power is corrected is transmitted to the base station device, even when a plurality of mobile station devices performs transmission by using the same allocated band for CB transmission, it becomes easier to remove the interference among users and thus it is possible to increase the possibility of avoiding transmission failure, by using, for example, turbo equalization or successive interference cancellation (SIC) based on the difference in reception power.

(7) Further, the mobile station device of the present invention determines an allocated band for CB transmission having a bandwidth corresponding to the available capacity of transmission power of the mobile station device, based on the control signal.

In this manner, since the allocated band for CB transmission having the bandwidth corresponding to the available capacity of transmission power of the mobile station device is determined based on the control signal, it is possible to perform the CB transmission in consideration of the path loss.

(8) Further, the mobile station device of the present invention determines, based on the control signal, an allocated band for CB transmission for which modulation and coding schemes (MCS) corresponding to the available capacity of transmission power of the mobile station device are configured.

In this manner, since an allocated band for CB transmission for which modulation and coding schemes (MCS) corresponding to the available capacity of transmission power of the mobile station device are configured is determined based on the control signal, it is possible to perform the CB transmission in consideration of the path loss.

(9) Further, the base station device of the present invention is a base station device which transmits a control signal for performing contention based (CB) transmission, to a mobile station device, and includes a scheduling unit that determines an allocated spectrum band in which the mobile station device performs the CB transmission; a control signal generation unit that generates a control signal for notifying the allocated spectrum band to the mobile station device; and a base station transmission unit that transmits the generated control signal to the mobile station device, in which the scheduling unit allocates respective spectra such that portions of the respective spectra are overlapped when a plurality of allocated spectrum bands are simultaneously determined.

In this manner, since respective spectra are allocated such that parts of the respective spectra are overlapped when a plurality of allocated spectrum bands are simultaneously determined, the number of candidates for the allocated band for CB transmission is capable of increasing as compared to the method in the related art, and it is possible to reduce the probability that a plurality of mobile station devices use completely the same band. Thus, it is possible to improve the transmission efficiency in the CB transmission.

(10) Further, the base station device of the present invention is a base station device which transmits a control signal for performing contention based (CB) transmission, to a mobile station device, and includes a scheduling unit that determines an allocated spectrum band in which the mobile station device performs the CB transmission; a de-mapping unit that extracts, from a received signal, a partial spectrum which is a portion of a spectrum allocated to the allocated spectrum band; and a signal detection unit that performs signal detection, by using the extracted partial spectrum.

In this manner, in the mobile station device, since the signal detection is performed by extracting a partial spectrum which is a spectrum in which a portion of spectrum is deleted among the spectra of the transmit signal, as the allocated band per CB transmission is narrowed, the number of the candidates for the allocated band for the CB transmission increases, and thus it is possible to reduce the collision probability. As a result, it becomes possible to improve the transmission efficiency in the CB transmission.

(11) Further, a wireless communication system of the present invention is a wireless communication system comprising a base station device and a mobile station device, in which the base station device includes a scheduling unit that determines an allocated spectrum band in which the mobile station device performs CB transmission; a de-mapping unit that extracts a partial spectrum which is a portion of a spectrum allocated to the allocated spectrum band, in a signal received from the mobile station device; and a signal detection unit that performs signal detection, by using the extracted partial spectrum, and in which the mobile station device includes a control information extraction unit that extracts a control signal for CB transmission from control information received from the base station device; a clipping unit that generates a partial spectrum by removing a portion of spectrum, from a spectrum of a transmit signal, based on the extracted control information for CB transmission; and a transmission unit that transmits a signal with the partial spectrum to the base station device.

In this manner, since the portion of the spectrum among the spectra of the transmit signal is removed, and a partial spectrum is generated, as the allocated band per CB transmission is narrowed, the number of the candidates for the allocated band for the CB transmission increases, and thus it is possible to reduce the collision probability. As a result, it becomes possible to improve the transmission efficiency in the CB transmission.

(12) Further, a transmission method of the present invention is a transmission method of a mobile station device that performs contention based (CB) transmission, based on a control signal received from a base station device, the method includes extracting control signal for CB transmission from the control information; generating a partial spectrum by removing a portion of spectrum, from a spectrum of a transmit signal, based on the extracted control information for CB transmission; and transmitting a signal with the partial spectrum, to the base station device.

In this manner, since the portion of the spectrum among the spectra of the transmit signal is removed, and a partial spectrum is generated, as the allocated band per CB transmission is narrowed, the number of the candidates for the allocated band for the CB transmission increases, and thus it is possible to reduce the collision probability. As a result, it becomes possible to improve the transmission efficiency in the CB transmission.

### Advantageous Effects of Invention

According to the present invention, it is possible to reduce a probability of a plurality of mobile station devices colliding at a time of using the CB transmission, and to improve a transmission throughput.

### BRIEF DESCRIPTION OF DRAWINGS

FIG. 1 is a block diagram illustrating a configuration example of a mobile station device 1 according to a first embodiment of the present invention.

FIG. 2 is a block diagram illustrating a configuration example of a base station device 3 according to the first embodiment of the present invention.

FIG. 3A is a diagram illustrating a band for CB transmission.

FIG. 3B is a diagram illustrating the CB transmission in the related art.

FIG. 3C is a diagram illustrating the CB transmission in a case of using the first embodiment of the present invention.

FIG. 4 is a block diagram illustrating a configuration example of a base station device 3 according to a second embodiment of the present invention.

FIG. 5A is a diagram illustrating a band for CB transmission.

FIG. 5B is a diagram illustrating the CB transmission in the related art.

FIG. 5C is a diagram illustrating the CB transmission in a case of using the second embodiment of the present invention.

FIG. 6 is a diagram illustrating an example in which a plurality of allocated bands for CB transmission are configured so as to overlap each other within a range of not exceeding the allowable overlap ratio, in the second embodiment of the present invention.

FIG. 7 is a flowchart illustrating an example of a process of a scheduling unit 211 according to the second embodiment of the present invention.

FIG. 8 is a block diagram illustrating an example of configuration of a mobile station device 1 according to a first modification example in the second embodiment of the present invention.

FIG. 9A is a diagram illustrating a band for CB transmission.

FIG. 9B is a diagram illustrating a case in which the half on a high-frequency side of a band is removed in the CB transmission according to a third embodiment of the present invention.

FIG. 9C is a diagram illustrating a case in which the half on a low-frequency side of a band is removed in the CB transmission according to the third embodiment of the present invention.

FIG. 10A is a diagram illustrating a case in which a removal ratio is 1/3, in the CB transmission according to the third embodiment of the present invention.

FIG. 10B is a diagram illustrating a case in which a removal ratio is 1/3, in the CB transmission according to the third embodiment of the present invention.

FIG. 10C is a diagram illustrating a case in which a removal ratio is 1/3, in the CB transmission according to the third embodiment of the present invention.

FIG. 10D is a diagram illustrating a case in which a removal ratio is 2/3, in the CB transmission according to the third embodiment of the present invention.

FIG. 10E is a diagram illustrating a case in which a removal ratio is 2/3, in the CB transmission according to the third embodiment of the present invention.

FIG. 10F is a diagram illustrating a case in which a removal ratio is 2/3, in the CB transmission according to the third embodiment of the present invention.

FIG. 11A is a diagram illustrating a case in which a base station device 3 according to a fourth embodiment of the present invention configures a different bandwidth for each allocated band for CB transmission.

FIG. 11B is a diagram illustrating a case in which the base station device 3 according to the fourth embodiment of the present invention configures a different bandwidth for each allocated band for CB transmission in each CC.

FIG. 11C is a diagram illustrating a case in which the base station device 3 according to the fourth embodiment of the present invention configures a different bandwidth for each allocated band for CB transmission in each CC.

FIG. 12A is a diagram illustrating a case in which the base station device 3 according to the fourth embodiment of the present invention configures a different MCS for each allocated band for CB transmission.

FIG. 12B is a diagram illustrating a case in which the base station device 3 according to the fourth embodiment of the present invention configures a different MCS for each allocated band for CB transmission in each CC.

FIG. 12C is a diagram illustrating a case in which the base station device 3 according to the fourth embodiment of the present invention configures a different MCS for each allocated band for CB transmission in each CC.

### DESCRIPTION OF EMBODIMENTS

Hereinafter, embodiments of the present invention will be described with reference to the drawings.

### First Embodiment

In the present embodiment, since a portion of a frequency spectrum of a data signal is not used for transmission at a time of using the CB transmission, a bandwidth required for transmission is narrowed. The base station device regards the spectra not being used for transmission as not being received due to a decrease in a radio channel and performs an interference cancellation by the non-linear iterative equalization process, and thus it is possible to suppress the deterioration of transmission performances. Narrowing the allocated band corresponding to one CB grant as described above means an increase in the number of CB grants of different allocated bands that may be used simultaneously for transmission, and it is possible to reduce a collision probability while maintaining a transmission rate. Hereinafter, configuration examples of a mobile station device and a base station device for realizing the present embodiment will be described.

[Configuration of Transmitter]

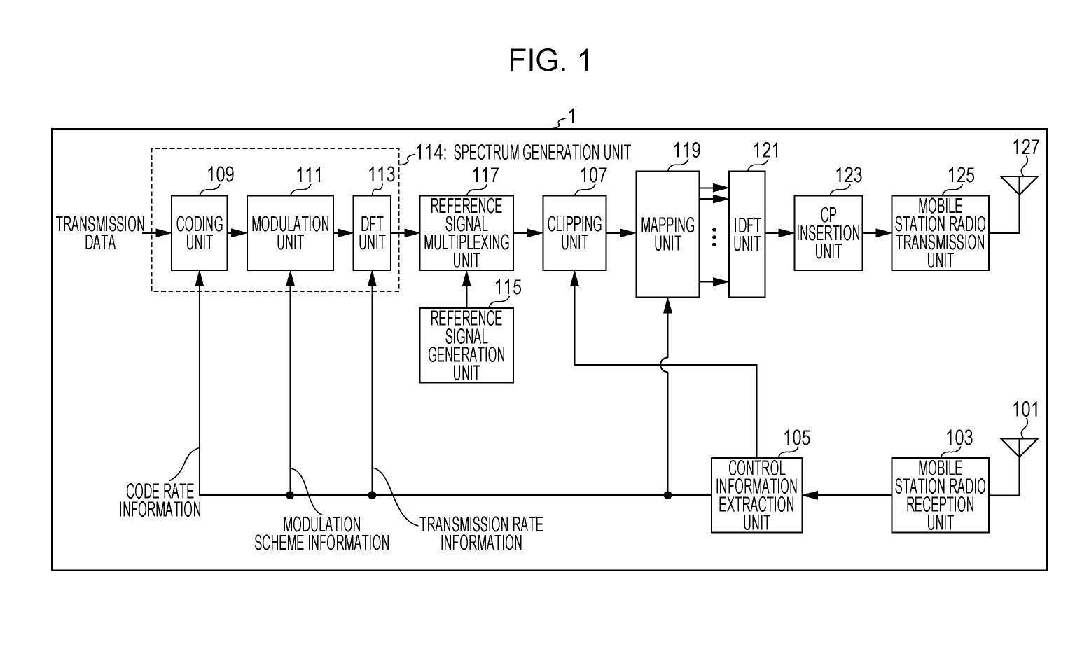

FIG. 1 is a block diagram illustrating a configuration example of a mobile station device 1 according to a first embodiment of the present invention. However, FIG. 1 illustrates necessary minimum blocks for describing the present invention. Further, although the number of antennas of the mobile station device 1 is one in FIG. 1, a known technology such as transmit diversity and an MIMO transmission may be applied by using a plurality of antennas for transmission and reception.

The mobile station device 1 is notified of various parameters used for transmission (the number of allocated resources, allocated band information, a modulation scheme, a coding rate, and the like) as control information from the base station device, before transmitting data. Therefore, in the mobile station device 1, a signal which is received in the receive antenna 101 from the base station device is subjected to a down-conversion and an analog to digital (A/D) conversion in the mobile station radio reception unit 103, and then input to a control information extraction unit 105.

The control information extraction unit 105 extracts control information used for transmission, from a signal input by the mobile station radio reception unit 103. Here, as the control information that the control information extraction unit 105 may extract, there are two types: control information for performing the CF transmission (individual pieces of control information that the base station device transmits, to a specific mobile station device 1 as a destination) and control information for performing the CB transmission (shared control information that the base station device transmits, to mobile station devices 1 capable of the CB transmission as destinations). Therefore, the control information extraction unit 105 extracts the CF transmission control information in a case of performing the CF transmission, and extracts the control information for CB transmission in a case of performing the CB transmission. The mobile station device 1 may determine whether to use either the CF transmission or the CB transmission, and the CB transmission may be determined to be used only when the CF transmission control information is not addressed to the mobile station device 1. The control information extraction unit 105 notifies the clipping unit 107 whether the extracted control information is for the CF transmission or for the CB transmission, and inputs the extracted control information to each block of the mobile station device 1, according to the usage application described later.

The coding unit 109 performs an error-correction coding on the transmission data, based on the coding rate information which is input by the control information extraction unit 105, and performs a modulation on the coded signal in a modulation unit 111. Here, the coding rate of the error-correction coding applied in the coding unit 109 and the modulation level applied in the modulation unit 111 are respectively selected, based on the coding rate information and the modulation scheme information, which are included in the control information notified from the control information extraction unit 105 (the modulation and coding scheme may be used as the information obtained by unifying the two pieces of information). The modulated signal is input to a DFT unit 113.

The DFT unit 113 converts the modulated signal into a frequency domain signal by Discrete Fourier Transform (DFT). Here, the number N_{DFT} of points of DFT (hereinafter, referred to as DFT point) is determined by using information regarding the number of allocated resources contained in the control information which is output from the control information extraction unit 105 (or may be calculated by allocated band information). Further, a block including components from the coding unit 109 to the DFT unit 113 is denoted by a spectrum generation unit 114.

In order to measure channel performance between the mobile station device 1 and the base station device which are required when the base station device performs a reception process, the reference signal generation unit 115 generates a known reference signal in the base station device. The generated reference signal, instead of a data signal, is input to the clipping unit 107 at a predetermined unit time (sub-frame) for measurement in a reference signal multiplexing unit 117. The data signal that is input from the DFT unit 113 is input to the clipping unit 107 at other unit times.

The clipping unit 107 receives information indicating whether the scheme used for transmission is either a CF transmission scheme or a CB transmission scheme, from the control information extraction unit 105, and performs a process on the frequency domain signal which is input from the DFT unit 113, based on the received information. Specifically, in a case of the CF transmission scheme, the input signal is output without being subjected to a process and in a case of the CB transmission scheme, a portion of the input signal is removed, and the remaining N points of the signal are output to a mapping unit 119. Here, the number (N_{DFT}-N) of points of a signal to be removed or a ratio ((N_{DFT}-N)/N_{DFT}) of the number of points in the case of the CF transmission may be determined in advance, or may be notified from the base station device through the control information. However, in the present invention, since it is important not to use a portion of spectrum for transmission in the CB transmission, the process in the CF transmission is not limited to the above described processes. In other words, even in the CF transmission, the same process as in the CB transmission may be performed and the spectrum may be deleted so as to be the number of points of a proportion different from the case of the CB transmission.

The mapping unit 119 allocates the signal that is input from the clipping unit 107 to subcarriers used for transmission. At this time, the allocation is performed based on the allocated band information of the N points given by the control information extraction unit 105, and a zero is inserted into the subcarriers not used for transmission.

The IDFT unit 121 converts the frequency domain signal that is input from the mapping unit 119 into a time domain signal by Inverse DFT (IDFT). If possible, a fast algorithm such as Fast Fourier Transform (FFT) and Inverse FFT (IFFT) may be applied to the DFT unit 113 and the IDFT unit 121, which are described above. Thereafter, a CP (a signal obtained by copying a portion on the rear part of the IDFT-converted symbol) is inserted into the obtained time domain signal in a cyclic prefix (CP) insertion unit 123. Next, the time domain signal is converted from a digital signal to an analog signal by a digital to analog (D/A) conversion and up-converted in a mobile station radio transmission unit (transmission unit) 125, and is transmitted from a transmit antenna 127.

[Configuration of Receiver]

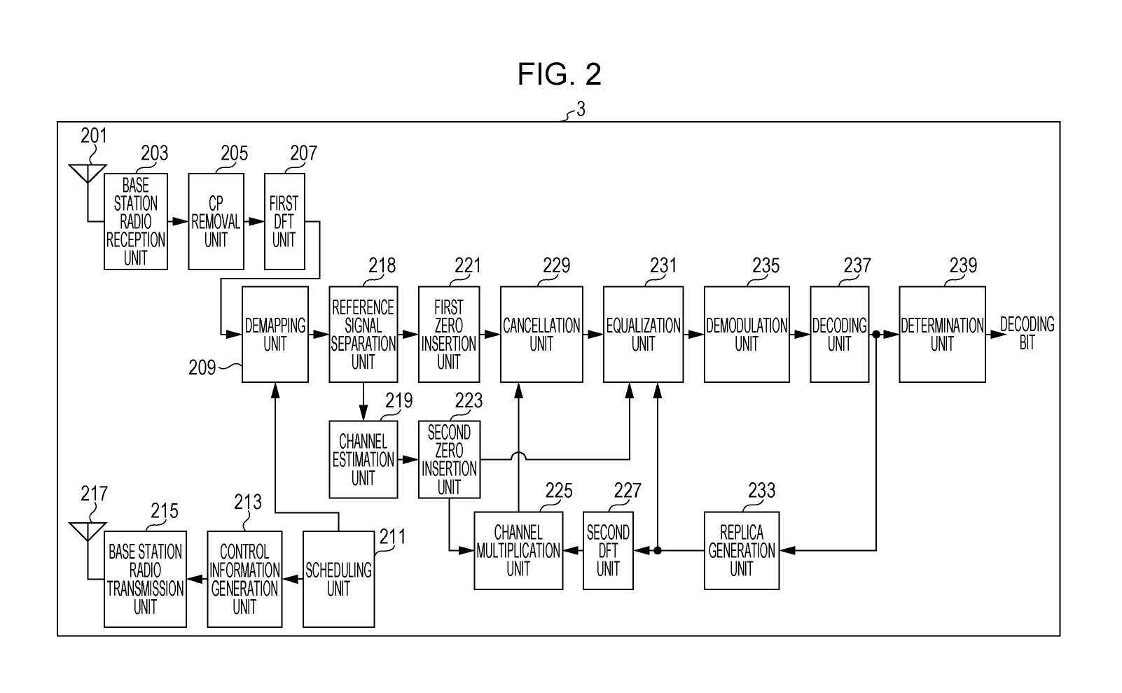

FIG. 2 is a block diagram illustrating a configuration example of a base station device 3 according to the first embodiment of the present invention. In the present embodiment, since the mobile station device 1 performs a process of not using a portion of frequency spectra for transmission when performing the CB transmission, the base station device 3 may not receive information regarding a portion of the spectrum, and thus inter-symbol interference occurs. Accordingly, a process of removing the interference in the reception process is required, and the base station device 3 including a reception device using frequency domain SC/MMSE turbo equalization will be illustrated herein. Further, although it is assumed that the number of antennas of the base station device 3 is one in FIG. 2, a known technology such as reception diversity and MIMO demultiplexing may be applied by using a plurality of antennas for reception.

Signals which are received in a receive antenna 201 from a singularity or a plurality of mobile station devices 1 are subjected to down-conversion and converted into digital signals by A/D conversion in a base station radio reception unit 203, and the CP is removed from the signal in a CP removal unit 205.

A first DFT unit 207 converts the signal which is input from the CP removal unit 205 from a time domain signal to a frequency domain signal by DFT, and inputs the frequency domain signal to a de-mapping unit 209.

A scheduling unit 211 has a function of determining a band to be allocated to the mobile station device 1 performing the CF transmission and a band for CB transmission. Any method may be used as the allocation method. For example, a band that may be allocated for the CB transmission and a band that may be allocated for the CF transmission are divided into different bands in advance, and the scheduling may be independently performed with respect to the band for CB transmission and the band for CF transmission. Further, as another method, after allocation is performed for each mobile station device 1 performing the CF transmission by using a known method such as Proportional Fairness or Round Robin, bands which have not been allocated to any mobile station device 1 may be used as bands that may be allocated for the CB transmission.

However, since the present embodiment has a characteristic that the mobile station device 1 does not use a portion of spectrum for transmission at a time of the CB transmission, the scheduling unit 211 configures the bandwidth for one CB transmission to the bandwidth of the transmitted partial spectrum. Therefore, when a transmission rate is determined in the CB transmission, if the bandwidth of a spectrum for realizing the transmission rate is set to N_{DFT}, the allocated bandwidth N for the CB transmission is configured to be narrower as compared to N_{DFT} (N<N_{DFT}). The generated allocation information is input to a control information generation unit (control signal generation unit) 213 and the de-mapping unit 209.

The control information generation unit 213 generates a control signal for notifying each mobile station device 1 of the allocated band and MCS used in the allocated band. Here, as the MCS to be used, the MCS which has been determined in advance in a system may be used, or the MCS may be determined based on the allocation information which is input from the scheduling unit 211. The generated control signals are mapped in radio resources so as to be orthogonal for each mobile station device 1 to which the control signal is notified, and the allocated band for CB transmission and information regarding MCS are mapped in radio resources that may be referred to by a plurality of mobile station devices 1 capable of CB transmission. The generated control signal is subjected to D/A conversion and up-conversion in a base station radio transmission unit (base station transmission unit) 215, and then is transmitted to each mobile station device 1 by a transmit antenna 217.

A de-mapping unit 209 separates the receive signal for each band that each mobile station device 1 has used for transmission, based on the allocation information input from the scheduling unit 211, and inputs a signal corresponding to each mobile station device 1 to a reference signal separation unit 218. The subsequent process is performed in parallel with a reception process for each mobile station device 1 that has been de-mapped, but a process for one mobile station device 1 will be described in this case, in order to avoid complicated description.

A reference signal separation unit 218 extracts a reception subframe of a demodulation reference signal, and inputs the extracted subframe to a channel estimation unit 219. The other signals are input to a first zero insertion unit 221. In the channel estimation unit 219, the sequence of the extracted reference signal before transmission is known. Accordingly, the channel estimation unit 219 estimates a frequency response of the channel used for transmission from the change amount of the reference signal from the sequence, and inputs the frequency response to a second zero insertion unit 223.

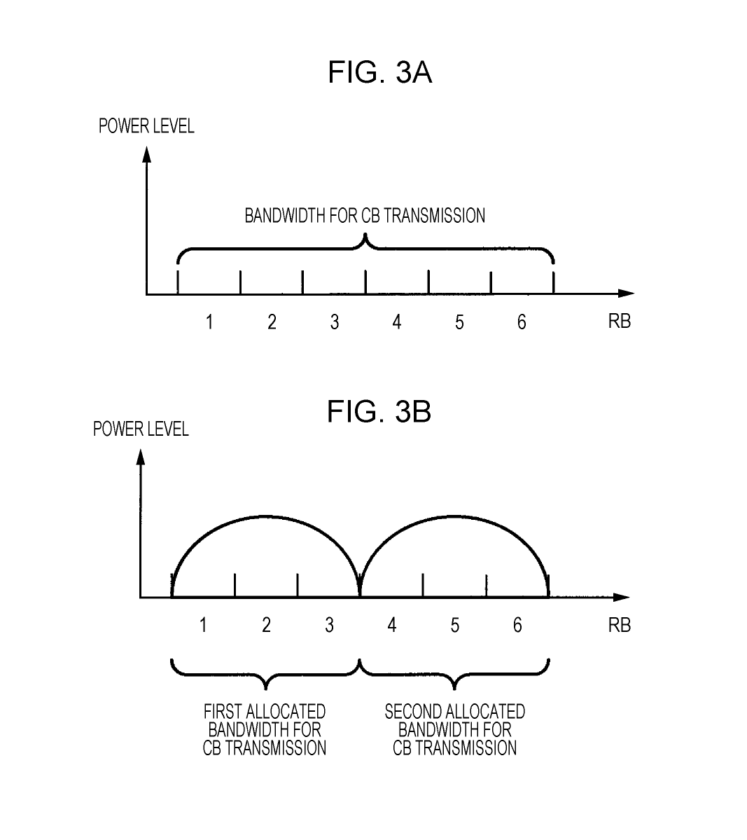

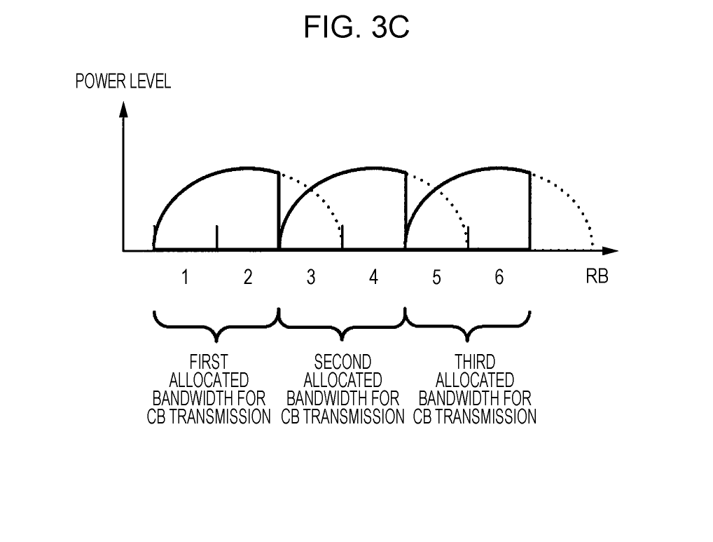

The first zero insertion unit 221 and the second zero insertion unit 223 perform different processes depending on whether the signal to be processed is a signal which has been received through the CF transmission or a signal which has been received through the CB transmission. When the input signal is based on the CF transmission, the input signal is output as it is without being subjected to any process. In contrast, when the input signal is based on the CB transmission, since a portion of the spectrum is removed in the mobile station device 1, a process of inserting a zero at the positions corresponding to the band which has been removed is performed. A case of using the first allocated band for CB transmission of FIG. 3C for this process will be described as an example. Since the signal extracted by the de-mapping process is based on the allocated band, the band is only two RBs of RB1 and RB2. However, the band of frequency spectra to be restored is originally three RBs, and thus one remaining RB is assumed to have failed in the transmission process by adding a zero, and the process for a receive signal spectrum of three RBs is performed. Accordingly, a zero is inserted into the response corresponding to the band of which spectra are removed even for the frequency response which is output from the channel estimation unit 219, and the zero-inserted response is output to a channel multiplication unit 225 and an equalization unit 231.

The channel multiplication unit 225 generates a reception replica signal by multiplying a frequency domain replica signal which is input from the second DFT unit 227 by an estimated channel value which is input from the second zero insertion unit 223, and inputs the obtained signal to a cancellation unit 229. The cancellation unit 229 cancels the replica of a desired signal by subtracting the frequency domain signal given from the channel multiplication unit 225 from the frequency domain signal which is input from the first zero insertion unit 221, and calculates the residual signal component. However, since the signal replica is not generated in the first process of the cancellation unit 229, the frequency domain signal given from the first zero insertion unit 221, as it is, without being subjected to the cancellation process, is output to the equalization unit 231.

The equalization unit 231 performs an equalization process by using the estimated channel values which are the outputs of the cancellation unit 229 and the second zero insertion unit 223, and after the conversion to the time domain is performed by the IDFT, the signal replica which is the output of a replica generation unit 233 is added, such that the desired signal is restored. Here, since a zero is inserted into the estimated channel value used in the equalization process, in the second zero insertion unit 223, the base station device 3 performs the equalization of processing the partial spectrum that has been removed in the mobile station device 1 as missing due to a decrease in the channel. It is possible to correctly reproduce the entire spectrum generated in the mobile station device 1 by such a process.

Since a demodulation unit 235 performs a demodulation process on the signal that is restored in the equalization unit 231, and error correction is performed in a decoding unit 237, a log likelihood ratio (LLR) of a sign bit is calculated. The reliability of the LLR obtained by the decoding process may be improved by repeating a process a certain number of times. When the process is repeated, the LLR is input to the replica generation unit 233 to generate a soft-replica of the signal, and when the repetition of the process is completed, the LLR is input to the determination unit 239. The determination unit 239 may obtain the decoded bits as the reception data by performing hard decision on the input LLR.

The replica generation unit 233 generates a soft replica according to the LLR of the sign bit. The generated replica is converted into a frequency domain signal in the second DFT unit 227, and then is input to the channel multiplication unit 225 described above. Further, the replica generation unit 233 inputs the generated replica to the equalization unit 231 to reconfigure the desired signal at a time of equalization.

Hitherto, a device configuration for realizing the present embodiment has been illustrated. If both the mobile station device 1 and the base station device 3 recognize a common value, any value may be used as the proportion of the partial spectrum to be removed at the time of performing the CB transmission. However, as the proportion increase, a high inter-symbol interference occurs, such that it is preferable that an appropriate value be configured according to an interference suppression capability of the reception device. Further, if notification through the control information or the like is possible, the proportion of the partial spectrum may be notified from the base station device 3.

However, when a portion of the spectrum is removed, the transmission energy of a signal is reduced, such that the deterioration of performance due to decreased energy may be suppressed by redistributing transmission power to the remaining spectra. The concept of the present embodiment will be described with reference to the drawings.

FIG. 3A is a diagram illustrating a band for CB transmission. A state in which six RBs of band available in the CB transmission are present is illustrated in FIG. 3A, with a minimum allocation unit of a spectrum in a frequency domain as a resource block (RB). Such a band may be a free band remaining after a band is allocated to the mobile station device 1 performing the CF transmission, or a dedicated band provided for the CB transmission. Accordingly, the band is not limited to a contiguous band as FIG. 3A, but may be a plurality of non-contiguous bands.

FIG. 3B is a diagram illustrating the CB transmission in the related art. Here, if a band of three RBs at a minimum is required for realizing a desired transmission rate in the CB transmission, as illustrated in FIG. 3B, for example, two allocated bands for CB transmission are prepared in the CB transmission in the related art in which RB1 to RB3 are set to a first allocated band for CB transmission, and RB4 to RB 6 are set to a second allocated band for CB transmission, and any group of mobile station devices in a cell is notified that the CB transmission is possible by using each transmission band. Here, if two mobile station devices 1 that perform the CB transmission are simultaneously present and it is assumed that each mobile station device 1 performs transmission while randomly selecting an allocated band for CB transmission without using time division multiplexing or the like, the probability that two mobile station devices 1 use the same band and thus collision occurs is 50%. Further, in the same manner, when three mobile station devices 1 that perform the CB transmission are present, a probability of the occurrence of collision in transmission of a certain mobile station device 1 is 1−(1/2×1/2)=75%.

Meanwhile, FIG. 3C is a diagram illustrating the CB transmission in the case of using the first embodiment of the present invention. It is assumed that the frequency spectra of the three RBs are required for realizing a desired transmission rate, similarly to the above description, but one RB among the three RBs is not used for transmission and the partial spectrum of two RBs is used for transmission. In this case, since the band to be allocated to each the CB transmission is two RBs, for example, three allocated bands for CB transmission are prepared in which RB1 and RB2 are set to a first allocated band for CB transmission, RB3 and RB4 are set to a second allocated band for CB transmission, and RB5 and RB6 are set to a third allocated band for CB transmission, and any group of mobile station devices in each cell is notified of the allocated bands.

In this case, when two mobile station devices 1 performing the CB transmission are present, the collision probability is 33%. When three mobile station devices 1 performing the CB transmission are present, the probability of the occurrence of collision in a certain mobile station device 1 is 1−(2/3×2/3)=56%. In this manner, in the first embodiment of the present invention, it is possible to suppress the number of allocated bands for realizing the same transmission rate, and thus the number of candidates of the allocated band for CB transmission may be further increased as compared to the related art. As a result, it is possible to suppress the probability of the occurrence of collision between a plurality of mobile station devices 1. However, the effect of reducing such a collision probability is obtained similarly even when four or more mobile station devices 1 are present. Further, here, the removal proportion is configured to 1/3, but it is possible to apply an arbitrary proportion if the spectrum removed in an interference cancellation process of the reception station may be restored by the proportion.

However, although the above example has been described assuming a case of not using time division multiplexing for simplicity, the effect of the reduction in collision probability due to an increase in the number of candidates of the allocated band for CB transmission on a frequency axis is similarly achieved even in the case where a plurality of transmission time candidates for the CB transmission are provided on a time axis by the time division multiplexing.

In the present embodiment, as the allocated band per CB transmission is narrowed by performing a process of removing a portion of the transmission spectra at a time of using the CB transmission, the number of the candidates for the allocated band for the CB transmission increases, and thus it is possible to reduce the collision probability. As a result, it is possible to improve the transmission efficiency in the CB transmission.

### Second Embodiment

In the present embodiment, since some allocated bands overlap each other between a plurality of CB grants that are prepared by the base station device 3 at a time of performing the CB transmission, the number of generated CB grants increases, and the probability of collision decreases which is caused by a plurality of mobile station devices 1 that perform transmission using the same CB grant.

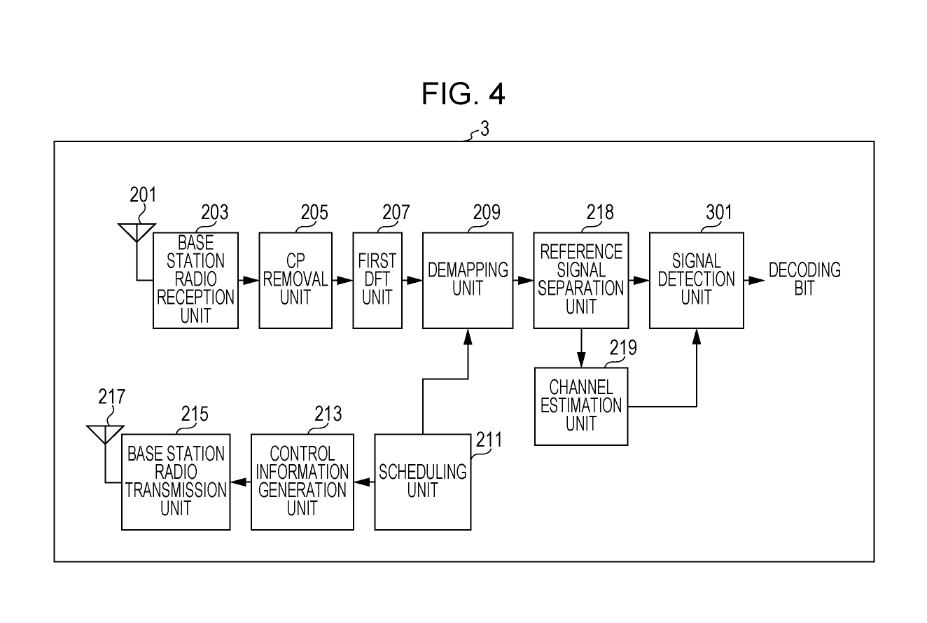

FIG. 4 is a block diagram illustrating a configuration example of a base station device 3 according to a second embodiment of the present invention. Since the blocks denoted by the same symbols as those in the base station device 3 in FIG. 2 have the same functions, the description thereof will be omitted, and the functions of the other blocks will be described below.

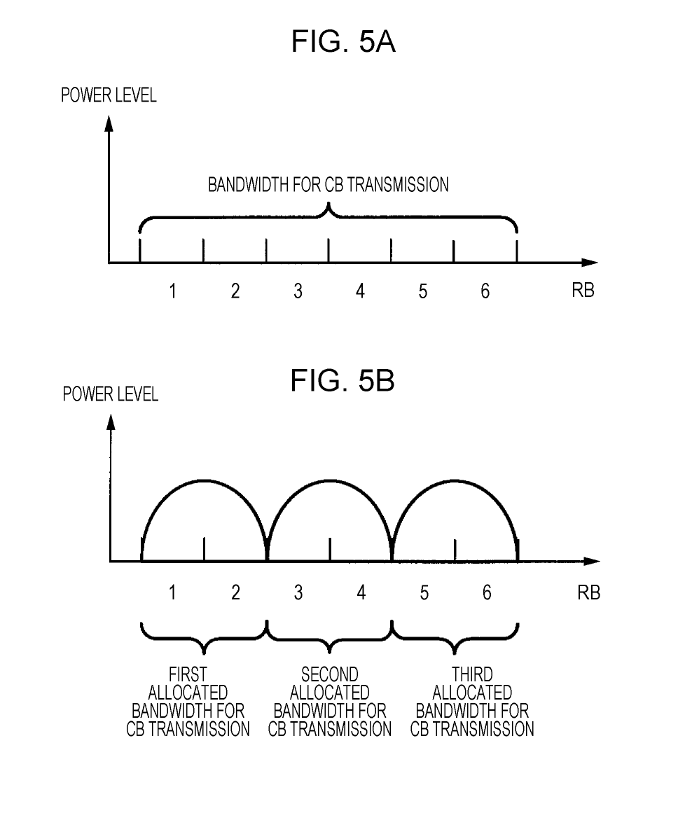

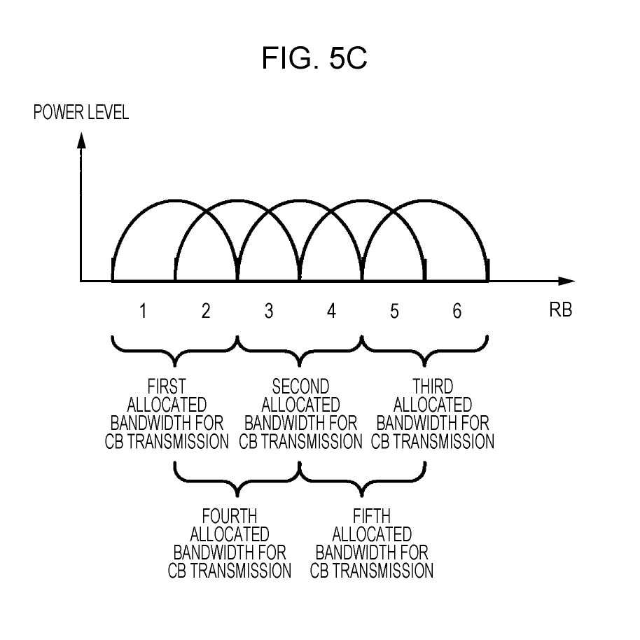

The scheduling unit 211 has a function of determining an allocated band used in the CB transmission. Specifically, the scheduling unit 211 determines a plurality of allocated bands for CB transmission, based on information regarding free bands for CB transmission which may be used in the CB transmission. Here, the free band for CB transmission may be a band which has not been allocated remaining after a band is allocated to each mobile station device 1 that performs the CF transmission, or a band that has been secured in advance for the CB transmission. In the scheduling unit 211, a proportion (here, referred to as an allowable overlap ratio) at which different allocated bands for CB transmission may overlap each other is determined in advance. However, when reception spectra from a plurality of mobile station devices 1 overlap, the ease of separation in a reception process varies depending on the MCS used for transmission, and the allowable overlap ratio may be configured based on the MCS used for the CB transmission. As illustrated in FIG. 5C described later, the scheduling unit 211 configures a plurality of allocated bands for CB transmission so as to overlap each other within a range of not exceeding the allowable overlap ratio, from the allowable overlap ratio that is configured as the free band for CB transmission, and a band used for one CB transmission.

The concept of the present embodiment will be described using the drawing. FIG. 5A is a diagram illustrating a band for CB transmission. FIG. 5A illustrates a state in which six RBs of free band that may be used in the CB transmission are secured, similarly to the case in FIG. 3A described above.

FIG. 5B is a diagram illustrating the CB transmission in the related art. Here, if the allocated band is assumed to be two RBs in the CB transmission, as illustrated in FIG. 5B, for example, three allocated bands for CB transmission are prepared in the CB transmission in the related art in which RB1 and RB2 are set to a first allocated band for CB transmission, RB3 and RB4 are set to a second allocated band for CB transmission, and RB5 and RB6 are set to a third allocated band for CB transmission. Then, one or more mobile station devices 1 capable of the CB transmission in a cell are notified that the CB transmission is possible using each transmission band. Here, if two mobile station devices 1 that perform the CB transmission are simultaneously present and it is assumed that each mobile station device 1 randomly selects an allocated band for CB transmission without using time division multiplexing or the like and performs transmission, the probability that two mobile station devices 1 use the same band and thus collision occurs is 33%. Further, when three mobile station devices 1 that perform the CB transmission are present, a probability that a certain mobile station device 1 collides with another mobile station device 1 is 1−(2/3×2/3)=56%.

In contrast, FIG. 5C is a diagram illustrating the CB transmission in a case of using the second embodiment of the present invention. Although frequency spectra of two RBs are required for realizing a desired transmission rate similarly to the above description, in the present embodiment, a portion (one RB) between allocated bands for CB transmission overlaps, and thus five allocated bands for CB transmission may be prepared in which RB2 and RB3 are set to a fourth allocated band for CB transmission and RB4 and RB5 are set to a fifth allocated band for CB transmission, in addition to the first allocated band for CB transmission, the second allocated band for CB transmission, and the third allocated band for CB transmission of FIG. 5B.

Thus, it is possible to reduce the collision probability to 20% when two mobile station devices 1 that perform the CB transmission are present. When three mobile station devices 1 that perform the CB transmission are present, it is possible to reduce the probability that a certain mobile station device 1 collides with another mobile station device 1 to 1−(4/5−4/5)=36%. Here, for example, when two mobile station devices 1 respectively and simultaneously use the first allocated band for CB transmission and the fourth allocated band for CB transmission, two mobile station devices 1 respectively use the spectra while the 50% of the respective spectra overlap each other. However, it is possible to further reduce the inter-user interference which occurs as compared to when two mobile station devices 1 use the same allocated band, and it is easy to realize the signal detection by applying an interference cancellation technology such as a non-linear iterative equalization. In other words, in the present embodiment, assuming that the separation by the interference cancellation technology is possible when spectra for performing a plurality of CB transmissions only partially overlap, allocated bands for CB transmission for which spectra partially overlap in a separable range are prepared, and the number of candidates of available allocated bands for CB transmission is increased, such that it is possible to reduce the probability of transmission failure caused by the plurality of mobile station devices 1 using the same allocated band for CB transmission.

Hereinafter, the configuration examples of the mobile station device 1 and the base station device 3 for realizing the second embodiment will be described. The mobile station device 1 according to the present embodiment may be realized in a normal mobile station device 1 that performs the CB transmission by using an allocated band for CB transmission which is notified through the control information by the base station device 3, and a special function is not required.

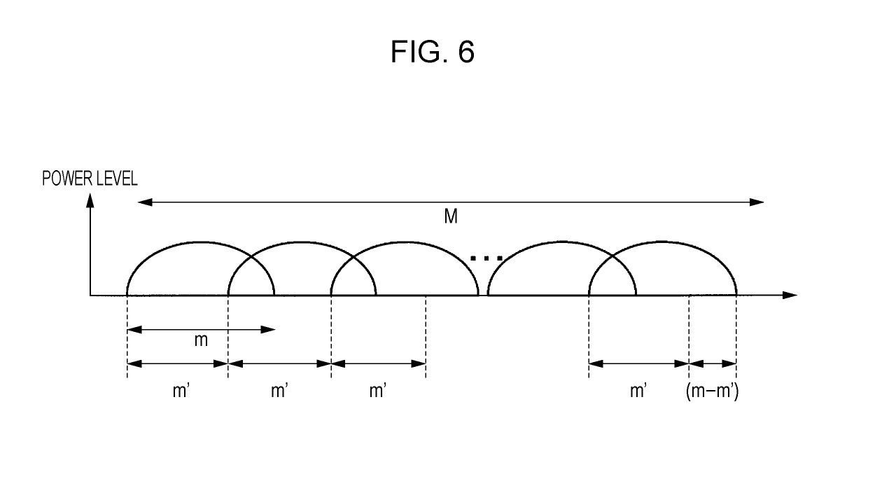

FIG. 6 is a diagram illustrating an example in which a plurality of allocated bands for CB transmission are configured so as to overlap each other within a range of not exceeding the allowable overlap ratio, in the second embodiment of the present invention. As illustrated in FIG. 6, it is assumed that M (RB) bands for the CB transmission are present, the bandwidth of one allocated band for CB transmission is m (RB), and the allowable overlap ratio between two allocated bands for CB transmission is P (<1). At this time, since the allocated band for CB transmission is mapped for each m′=ceil (m−(1−P)) (RB), floor ((M−(m−m′))/m′) of allocated bands for CB transmission may be allocated. Here, the floor (A) is a floor function indicating the largest integer in a range of being equal to or less than A, and the ceil (A) is a ceiling function indicating the smallest integer in a range of being equal to or more than A. An exemplary arrangement is illustrated based on the assumption that if the overlap ratio of the two allocated bands for CB transmission is within a certain value, even when the band overlaps two or more allocated bands for CB transmission simultaneously, the band is separable. However, for example, a certain allocated band for CB transmission may be scheduled so as to overlap only one allocated band for CB transmission.

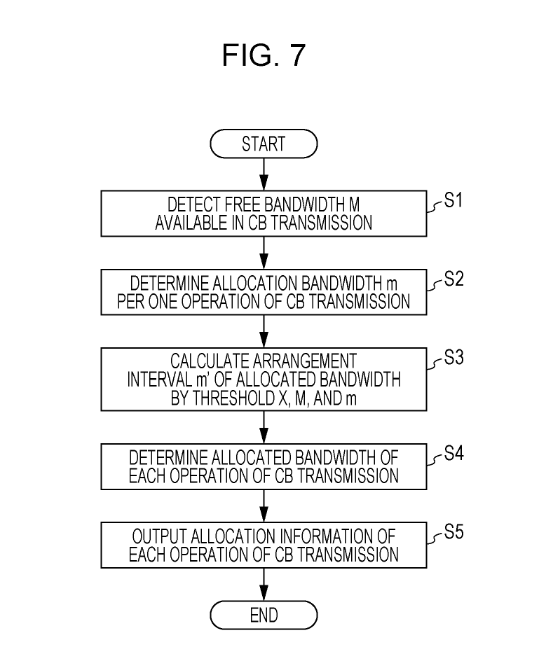

FIG. 7 is a flowchart illustrating an example of a process of the scheduling unit 211 according to the second embodiment of the present invention. First, the bandwidth M of the free band available in the CB transmission is detected (step S1). However, when the band available in the CB transmission is determined in advance, step S1 is not required. Next, the bandwidth m used for each one CB transmission is determined from the transmission rate required in the CB transmission (step S2). However, when the transmission rate is determined in advance, the determined m is used. Subsequently, the arrangement interval m′ of allocated bands for CB transmission is determined by m′=ceil (M/(m−X), by using a threshold X which is configured in a system (step S3). Here, X is a threshold for making the bandwidth to be overlapped be equal to or less than an allowable value when allocated bands of the bandwidth m are mapped for each m′. Next, each allocated band for CB transmission mapped at each m′ is determined (step S4), and information regarding the determined allocated bands is output to the control information generation unit 213 and the de-mapping unit 209 (step S5).

Returning to FIG. 4, a signal detection unit 301 has a function of performing signal detection such as equalization, demodulation of modulated symbols, error correction decoding, and outputting a decoded bit. However, in the present embodiment, since there is a possibility that a plurality of mobile station devices 1 perform reception while some spectra overlap as illustrated in FIG. 5C, it is preferable to use an interference cancellation technology of detecting the signal of each mobile station device 1 in serial by ranking as non-linear iterative equalization (turbo equalization) based on a turbo principle or successive interference cancellation (SIC) in order to separate the respective spectra.

### First Modification Example

As a modification example of the second embodiment, transmission power in the mobile station device 1 may be set so as to output a difference in transmission power between the spectra from a plurality of mobile station devices 1 which receives signals in the CB transmission. Generally, when a technology of capable of cancelling an inter-user interference, such as turbo equalization and SIC is used, as there is a difference in the likelihood of the decoded bits for each user, an improvement effect resulting from using likelihood information is achieved. Therefore, the effect of easily realizing the separation of signals between users by interference cancellation is achieved by setting reception powers to be different between the mobile station devices 1. For example, Expression (1) may be used for determining transmission power in the mobile station device 1.

[Math 1]

P=10 log₁₀(W)+p_{R0}+α·PL+Δ_{TF}+F (1)

Here, p_{R0} is a target reception power level of frequency allocation notified from the base station device 3. α is a cell-specific parameter including 0 and 1 which are configured in a range from 0 to 1 used in a technology called Fractional TPC, W is a bandwidth used for transmission by the mobile station device 1, Δ_{TF} is a value for correcting the necessary reception power which varies for each MCS. Further, F is a correction value that may be configured in the mobile station device 1. For example, F may be a value determined from C-RNTI which is an identifier different for each mobile station device 1, and may be randomly configured in a predetermined range.

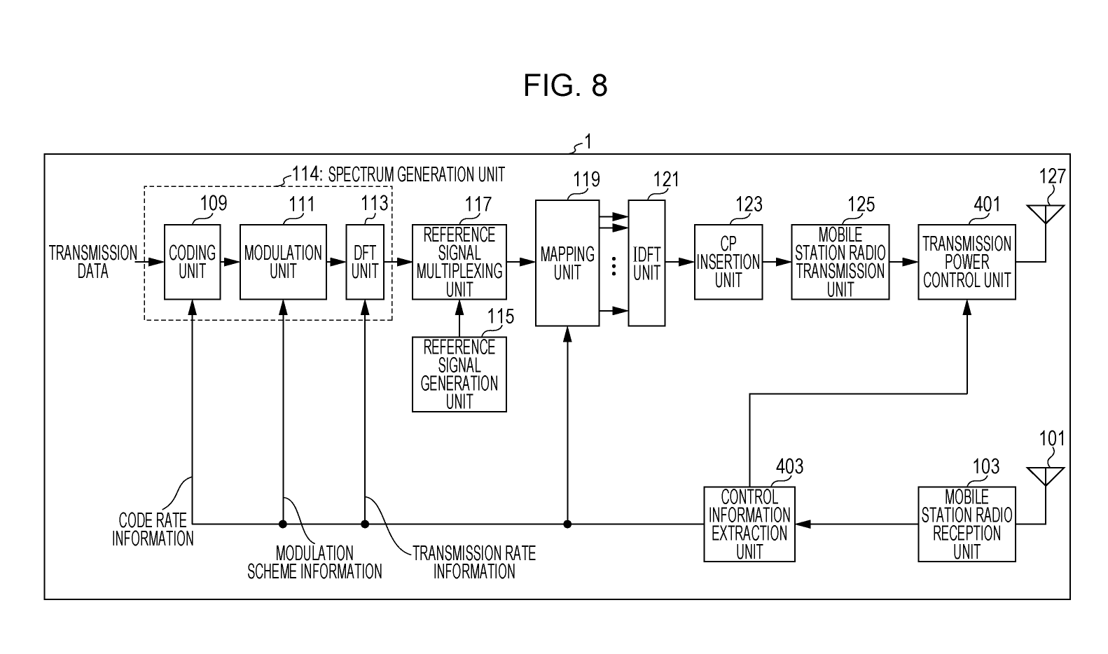

FIG. 8 is a block diagram illustrating an example of configuration of a mobile station device 1 according to a first modification example of the second embodiment of the present invention. The mobile station device 1 of FIG. 8 is different from the mobile station device 1 of FIG. 1 according to first embodiment in that the clipping unit 107 is removed and the transmission power control unit 401 is added. Further, when the control information used for transmission is for the CB transmission, the control information extraction unit 403 notifies the transmission power control unit 401 that the CB transmission is to be performed (for example, one bit information).

The transmission power control unit 401 has a function of setting the transmission power of the transmit signal that is input from the mobile station radio transmission unit 125, to an arbitrary value. For example, Expression (1) is used as a determination expression. When it is notified from the control information extraction unit 403 that the CB transmission is to be performed, F is set to a different value for each mobile station device 1, as described above, and transmission power is determined by setting F=0 in other cases. However, when respective parameters of Expression (1) are configured by control information, the parameters are input from the control information extraction unit 403, and when the parameters are notified from a higher layer, the parameters are extracted from the data signal which has been restored in a downlink, and input to the transmission power control unit 401. The transmit signal of which transmission power is adjusted is transmitted to the base station device 3 by the transmit antenna 127. However, the transmission power control unit 401 is disposed, for example, ahead of the mobile station radio transmission unit 125, and the adjustment of transmission power may be configured to be performed prior to the process of the mobile station radio transmission unit 125.

In a case of using such a modification example, even when a plurality of mobile station devices 1 perform transmission by using the same allocated band for CB transmission (when collision occurs), it is easy to realize the inter-user interference cancellation by using turbo equalization and SIC from the difference between the reception power, and the possibility of being capable of avoiding transmission failure is increased.

In the present embodiment, at a time of using the CB transmission, the base station device 3 configures a plurality of allocated bands for CB transmission so as for a portion thereof to overlap each other, the number of candidates of the allocated band for CB transmission further increases as compared to the method in the related art, and thus it is possible to suppress a probability that a plurality of mobile station devices 1 use completely the same band. As a result, it is possible to improve the transmission efficiency in the CB transmission.

### Third Embodiment

The present embodiment illustrates a wireless communication system in which when a plurality of mobile station devices 1 perform the CB transmission by using the same transmission band, a communication scheme is used in which each mobile station device 1 does not use any portion of the spectrum for transmission, and thus the probability of transmission failure due to collision is reduced.

A transceiver configuration for realizing the present embodiment will be described. A mobile station device 1 according to the present embodiment may be realized by the same block configuration as in FIG. 1 which is a configuration example of the mobile station device 1 of the first embodiment. However, since the function of the clipping unit 107 is different, the clipping unit 107 will be described below.

When it is notified from the control information extraction unit 105 that the CB transmission is to be performed, the clipping unit 107 according to the present embodiment removes any part of the spectra that have been input from the reference signal multiplexing unit 117. The spectra to be removed may be determined randomly, or may be configured based on a certain rule. For example, a rule may be used in which different portions are removed depending on whether identification information (which may be referred to as a Cell-Radio Network Temporary Identity (C-RNTI)) by which the base station device 3 identifies the mobile station device 1 is represented by an odd number or an even number.

The base station device 3 according to the present embodiment may be realized by the same block configuration as in FIG. 2 which is a configuration example of the base station device 3 of the first embodiment. However, since the functions of the de-mapping unit 209, the first zero insertion unit 221 and the second zero insertion unit 223 are different, they will be described below.

The de-mapping unit 209 according to the present embodiment has a function of extracting a reception spectrum of an allocated band corresponding to each mobile station device 1, but the reception spectrum of the allocated band for CB transmission is extracted for each transmission band of the partial spectrum that is used for transmission in the mobile station device 1 described above. The details will be described later. The concept of each embodiment will be described using the drawings.

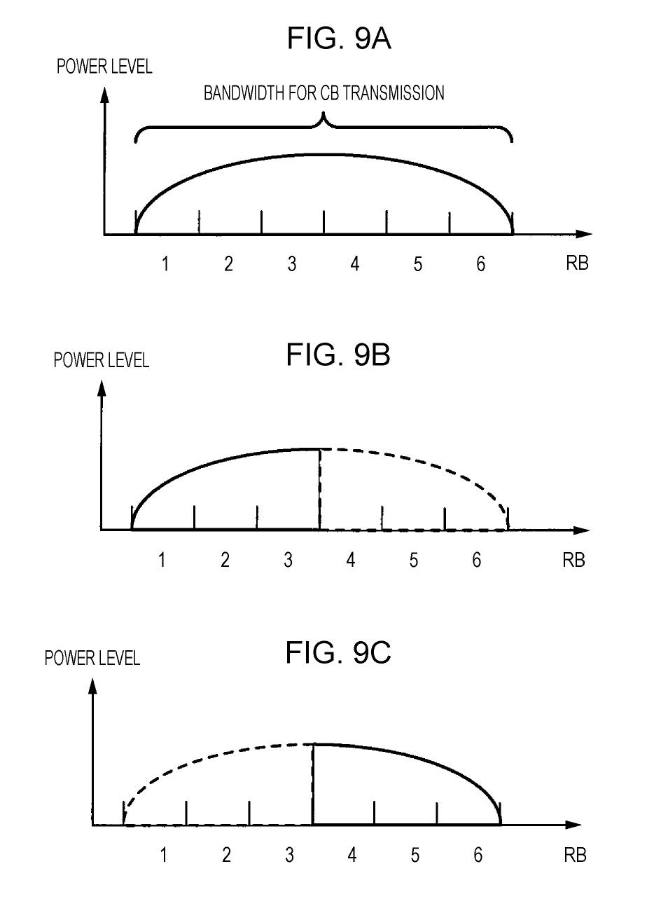

FIG. 9A is a diagram illustrating a band for CB transmission. FIG. 9A illustrates a case in which six RBs (RB1 to RB6) are secured as the allocated band for CB transmission. In this case, if two mobile station devices 1 simultaneously perform the CB transmission by using the band, there is a high possibility of the transmission failure due to collision. Thus, as FIG. 9B or FIG. 9C, each mobile station device 1 performs a process of removing any half of the spectrum.

FIG. 9B is a diagram illustrating a case in which the half on a high-frequency side of a band is removed in the CB transmission according to a third embodiment of the present invention. In the case of FIG. 9B, the mobile station device 1 removes the partial spectrum corresponding to RB4 to RB6, and performs transmission only on the partial spectrum corresponding to RB1 to RB3.

In contrast, FIG. 9C is a diagram illustrating a case in which the half on a low-frequency side of a band is removed in the CB transmission according to the third embodiment of the present invention. In the case of FIG. 9C, the mobile station device 1 removes the partial spectrum corresponding to RB1 to RB3, and performs transmission only on the partial spectrum corresponding to RB4 to RB6. Whether to use FIG. 9B or FIG. 9C may be arbitrarily determined for each mobile station device 1. In a case of the transmission using the six RBs in the related art, the probability of the occurrence of collision is 100% when two mobile station devices 1 perform transmission based on the same control information, but the probability of removing the same partial spectrum is 50% by performing the present process, and thus the probability of the spectra from two mobile station devices 1 colliding is 50%. Further, when three mobile station devices 1 perform the CB transmission by the same control information, the probability that the other two mobile station devices 1 collide with a certain mobile station device 1 is 1−(1/2×1/2)=75%. When the transmitted partial spectrum does not collide with another mobile station device 1, the base station device 3 extracts the partial spectrum from the mobile station device 1, and restores the signal by removing the inter-symbol interference caused by the loss of a portion of spectrum by using an interference cancellation technology such as turbo equalization or SIC.

However, the case of removing the half of the spectrum is exemplified here, but when the separation caused by interference cancellation technology is possible, even if the proportion in which the spectrum is deleted is half or more, or half or less, the proportion is included in the present invention.

The operation of the de-mapping unit 209 described above will be described with reference to the examples of FIG. 9A to FIG. 9C. Among RB1 to RB6, if it is assumed that the mobile station device 1 is a system performing a removal process of the partial spectrum of FIG. 9B or FIG. 9C, the de-mapping unit 209 considers RB1 to RB3 and RB4 to RB6 to be reception spectra from different mobile station devices 1, and outputs the respective partial spectra to the reference signal separation unit 218 in parallel. According thereto, when the reception spectrum through the CB transmission is processed, the first zero insertion unit 221 and the second zero insertion unit 223 according to the present embodiment changes the position to which zero is inserted, depending on whether the partial spectrum that is extracted in the de-mapping unit 209 is obtained by removing the spectrum corresponding to a band among the bands for CB transmission.

In a case of using examples of FIG. 9B and FIG. 9C, when the spectrum that is extracted in the de-mapping unit 209 is RB1 to RB3, the first zero insertion unit 221 and the second zero insertion unit 223 insert a zero to the RB4 to RB6 (three RBs corresponding to higher frequency than the partial spectrum), and when the extracted spectrum is RB4 to RB6, a zero is inserted into the RB1 to RB3 (three RBs corresponding to a lower frequency than the partial spectrum). By performing such a process, it is possible to perform a reception process independently without the signals from a plurality of mobile station devices 1 using the same allocated band for CB transmission interfering with each other.

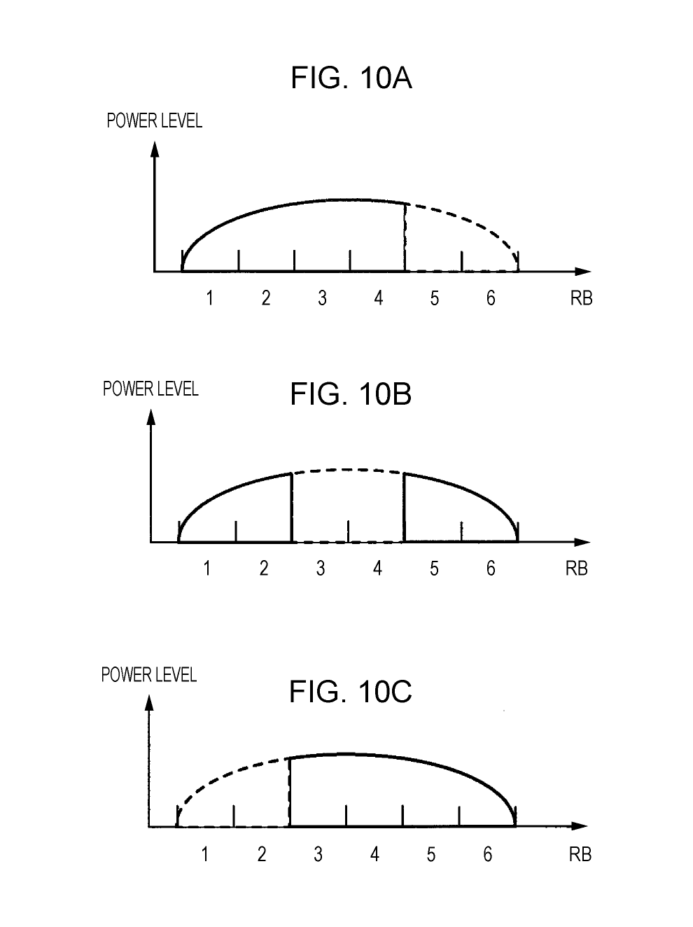

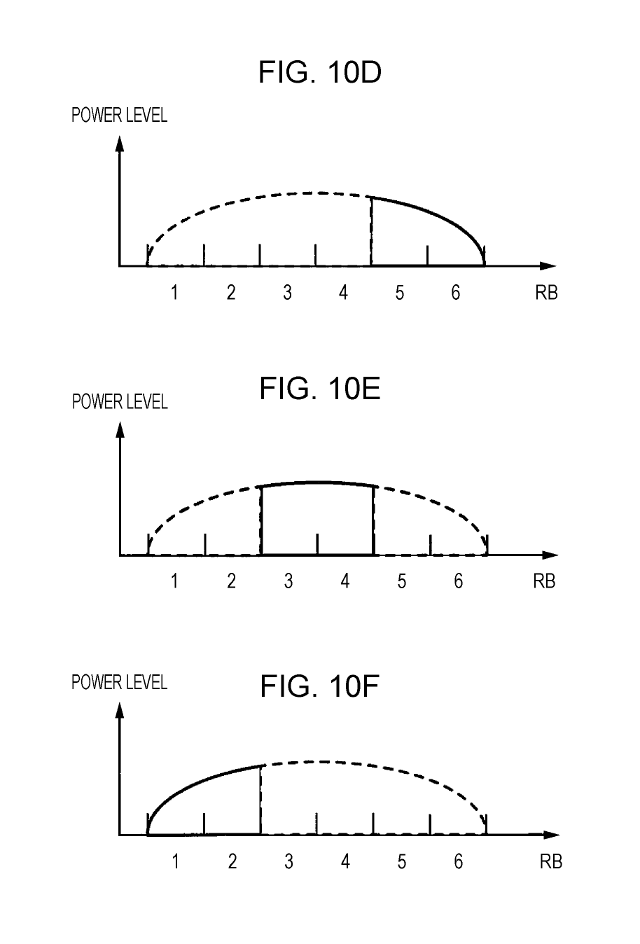

FIGS. 10A to 10C are diagrams illustrating a case in which a removal ratio is 1/3, in the CB transmission according to the third embodiment of the present invention. FIGS. 10D to 10F are diagrams illustrating a case in which a removal ratio is 2/3, in the CB transmission according to the third embodiment of the present invention. As illustrated in FIGS. 10A to 10C, three candidates may be prepared so as to remove 1/3 of the spectrum, and as illustrated in FIGS. 10D to 10F, three candidates may be prepared so as to remove 2/3 of the spectrum. However, when the removal ratio is set to be half or less as FIGS. 10A to 10C, even when a plurality of mobile station devices 1 remove a different portion of the spectrum, some of the spectra overlap each other, and thus an inter-user interference occurs. Accordingly, similarly to the second embodiment, it is preferable that an interference cancellation technology be applied so as to remove the inter-user interference. Further, when a process of removing some of spectra is performed, deterioration of performance due to the reduction in transmission energy is considered, such that the energy corresponding to the removed spectrum is redistributed to a partial spectrum used for transmission, and the maintenance of transmission energy may be intended.

In the present embodiment, in a case of transmitting the CB transmission, a process of removing the spectrum of some of the band for CB transmission is performed. At this time, a plurality of candidates in which the positions of the spectra to be removed are different are prepared, even when the plurality of mobile station devices 1 use the same control information for the CB transmission, a probability of collision is reduced, and as a result, it is possible to improve the transmission efficiency in the CB transmission.

### Fourth Embodiment

Since the CB transmission starts transmission before a base station device 3 which is a reception station specifies a mobile station device 1 which is a transmission station, the base station device 3 may not select MCS and allocate a bandwidth in consideration of the channel state from the mobile station device 1, differently from the CF transmission. Accordingly, if the control suitable for the case of the CF transmission is applied similarly to the CB transmission, it is not suitable for the CB transmission, and there is a problem of more deterioration in transmission performances than necessary. The present embodiment illustrates an aspect for solving such a problem.

### [Aspect of Setting Suitable Transmission Power in the CB Transmission]

In the present embodiment, transmission power control at a time of performing the CB transmission will be described. Generally, when the mobile station device 1 determines the transmission power of a data signal, control by Expression (2) is considered.

[Math 2]

P=10 log₁₀(m)+P₀+α·PL+Δ_{TF}+f (2)

Here, each variable is a decibel (dB) value. Here, m is a bandwidth (RB) used for transmission, P₀ is a desired reception power that is notified from the base station device 3, and Δ_{TF} is a correction value that is determined according to MCS. f is a correction value of a closed loop that is notified from the base station device 3 in order to correct the excess and deficiency of reception power of the base station device 3. However, if the feedback from the base station device 3 is not required, f may be omitted, or the mobile station device 1 may set such that f=0. α is a parameter equal to or less than 1 that is configured when a known technology called fractional Transmission Power Control (TPC) is used, and α=1 when the fractional TPC is not used. PL is a path loss between the mobile station device 1 and the base station device 3, and is determined by, for example, the reception power of a downlink reference signal that is transmitted from the base station device 3 in LTE. In other words, assuming that the path loss of the downlink signal and the path loss of the uplink signal are almost the same, the transmission power ensuring path loss of the uplink signal is determined by using the downlink path loss value.

However, while the base station device 3 allocates an appropriate bandwidth for an uplink line by scheduling to the mobile station device 1 in the CF transmission used in LTE, since the mobile station device 1 using a bandwidth is unknown at the stage of allocation and in fact, the bandwidth for an uplink line is randomly selected in the CB transmission, a bandwidth having a lower channel gain is used in the CB transmission as compared to a case of the CF transmission. Meanwhile, the path loss in the downlink line is measured in the same manner in the CF transmission and the CB transmission. From the above description, in the present embodiment, the mobile station device 1 determines transmission power by Expression (3).

[Math 3]

P=10 log₁₀(m)+P₀+α·PL+Δ_{TF}+Δ_{CB}+f (3)

Here, Δ_{CB} is an offset value for compensating a reduction in channel gain at the time of the CB transmission. For example, Δ_{CB} is configured as in Expression (4).

$$\begin{matrix}[ Math 4 ] & \\ {Δ}_{CB} = \{ \begin{matrix}X & ( WHEN CB TRANSMISSION ) \\ 0 & ( WHEN CF TRANSMISSION )\end{matrix} & ( 4 )\end{matrix}$$

Here, since X is a value of 1 or more and the difference in performance due to the scheduling depends on the fading, Δ_{CB} may be a predetermined value that is determined based on a statistical value in the system in order to omit unnecessary control.

Further, expressions for respectively determining transmission power in the CF transmission and the CB transmission may be used. Expression (5) is an example thereof.

[Math 5]

P_{CF}=10 log₁₀(m_{CF})+P₀_{_{—}}_{CF}+α·PL+Δ_{TF}+f_{CF}

P_{CB}=10 log₁₀(m_{CB})+P₀_{_{—}}_{CB}+α·PL+Δ_{TF}+f_{CB} (5)

Here, P_{CF} is transmission power used at the time of the CF transmission, and P_{CB} is transmission power used at the time of the CB transmission. Further, m_{CF} and m_{CB} are respective allocated bandwidths that are specified in the respective pieces of control information for the CF transmission and the CB transmission, and P₀_{_{—}}_{CF} and P₀_{_{—}}_{CB} are respective pieces of target transmission power that are notified from the base station device 3 at the time of performing the CF transmission and the CB transmission. f_{CF} is a correction value of a closed loop that the base station device 3 notifies to the mobile station device 1 for the CF transmission, and f_{CB} is a correction value of a closed loop that the base station device 3 notifies to the mobile station device 1 for the CB transmission. The mobile station device 1 may respectively perform transmission power control in the CF transmission and the CB transmission by using the transmission power determination expression such as Expression (5).

However, since a process of specifying a destination is necessary in order to correct a closed loop for notifying the excess and deficiency of the reception power in the CB transmission in which a plurality of destinations are contained in the control information, it is possible to omit the process of specifying the destination through an aspect in which the base station device 3 notifies a correction value of the closed loop only at the time of the CF transmission by not using f_{CB} in Expression (5) or setting f_{CB}=0. Further, the base station device 3 may set the transmission power different from that in the CF transmission when the mobile station device 1 performs the CB transmission, by using transmission power control of Expression (5). Therefore, it is possible to determine suitable transmission power while accelerating the transmission start of the uplink control signal by the CB transmission through an aspect in which a signal different from an uplink data signal, for example, an uplink control signal is transmitted by the CB transmission.

[Aspect in which Mobile Station Device 1 Selects Bandwidth and MCS in the CB Transmission]

Further, since the base station device 3 determines a predetermined MCS and an allocated bandwidth, without depending on the mobile station device 1 that actually performs transmission in the CB transmission, it is necessary for the mobile station device 1 to use the MCS and the allocated bandwidth which are given without considering a path loss. However, for example, it is preferable that the mobile station device 1, which is separate from the base station device 3 and has a large path loss, use a low order modulation scheme, a low coding rate, and a narrow band in order to reduce the transmission power, and it is preferable that the mobile station device 1, which is close to the base station device 3 and has a small path loss, use a high order modulation scheme, a high coding rate, and a wide bandwidth in order to increase the transmission rate. Accordingly, in the present example, when a plurality of allocated bands for CB transmission are prepared, different MCS or allocated bandwidths are configured for the respective allocated bands for CB transmission.

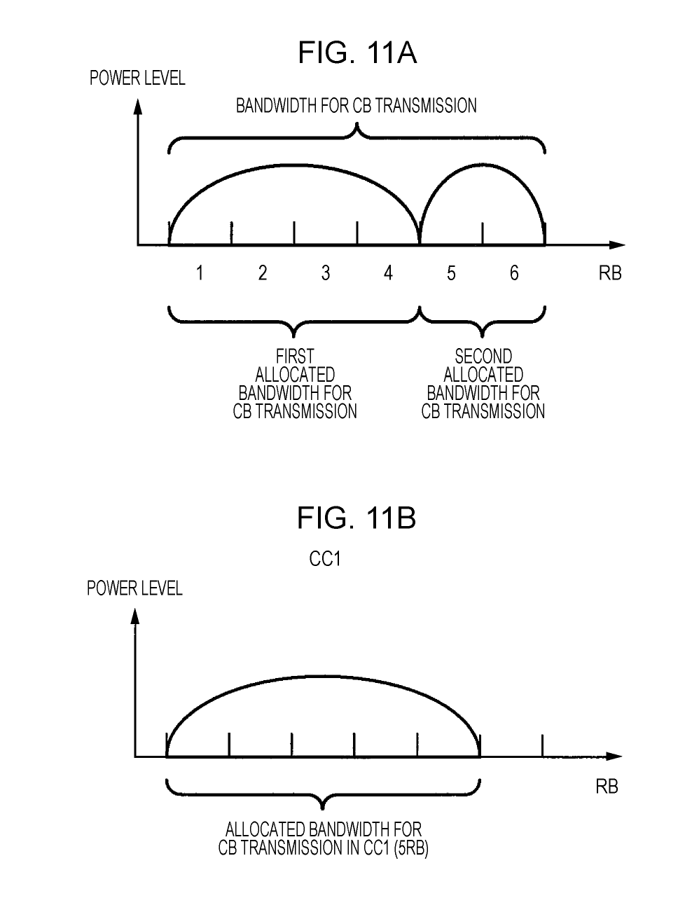

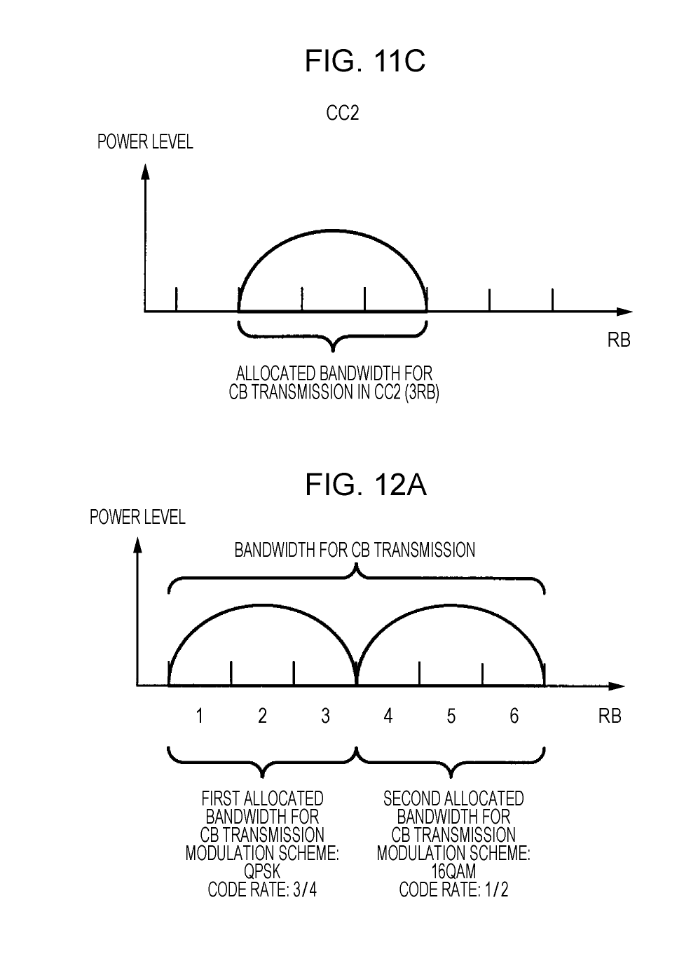

FIG. 11A is a diagram illustrating a case in which a base station device 3 according to a fourth embodiment of the present invention configures a different bandwidth for each allocated band for CB transmission. In FIG. 11A, when six RBs of allocated bands for CB transmission are present, the base station device 3 allocates two allocated bands for CB transmission including a first allocated band for CB transmission having four RBs (RB1 to RB4) of bandwidth and a second allocated band for CB transmission two RBs (RB5 and RB6) of bandwidth. The two allocated bands for CB transmission are respectively notified to the mobile station device 1 as different CB grants. The mobile station device 1 extracts two CB grants, and determines whether to use the first allocated band for CB transmission having a wide bandwidth or the second allocated band for CB transmission having a narrow bandwidth, according to the available capacity of transmission power of the mobile station device 1. For example, the band reference m_{target} (a) is calculated as a function of MCS.

[Math 6]

m_{target}(a)10̂{P_{target}−(P₀+α·PL+Δ_{TF}(a))} (6)

P_{target} is reference transmission power in the CB transmission, and Δ_{TF}(a) is a power correction value to be compensated at the time of using the MCS indicated by the index a. The mobile station device 1 selects one band having a bandwidth smaller than m_{target}(a) (a) among selectable allocated bands for CB transmission and uses the selected band for CB transmission. However, in order to improve the transmission rate to be high as possible, the allocated band for CB transmission having a maximum bandwidth in a range of being equal to or less than m_{target}(a) (a) may be selected.

Further, FIG. 11A illustrates a case of allocating a plurality of allocated bands for CB transmission in the same frequency band, but a similar process is possible even when the allocated bands for CB transmission are allocated in respective frequency bands that are separate by certain frequencies or more. For example, in LTE, a scheme called Carrier Aggregation (CA) is employed, and thus one or more CCs are selected for transmission from a plurality of frequency bands each called a Component Carrier (CC). At this time, when allocated bands for CB transmission are allocated for respective CCs, the base station device 3 allocates the allocated bands for CB transmission having different bandwidths for the respective CCs.

FIGS. 11B and 11C are diagrams illustrating a case in which the base station device 3 according to the fourth embodiment of the present invention configures a different bandwidth for each allocated band for CB transmission in each CC. In FIGS. 11B and 11C, five RBs of allocated bands for CB transmission are allocated in CC1, and three RBs of allocated bands for CB transmission are allocated in CC2. The base station device 3 notifies the allocated band for CB transmission in each CC as each CB grant, to the mobile station device 1. Then, the mobile station device 1 selects a CC of a selectable bandwidth based on the reference of Expression (6) similarly to the case of FIG. 11A, and performs the CB transmission. Further, as described above, since the transmission power required in the mobile station device 1 varies depending on the used MCS, a different MCS is configured for each allocated band for CB transmission.

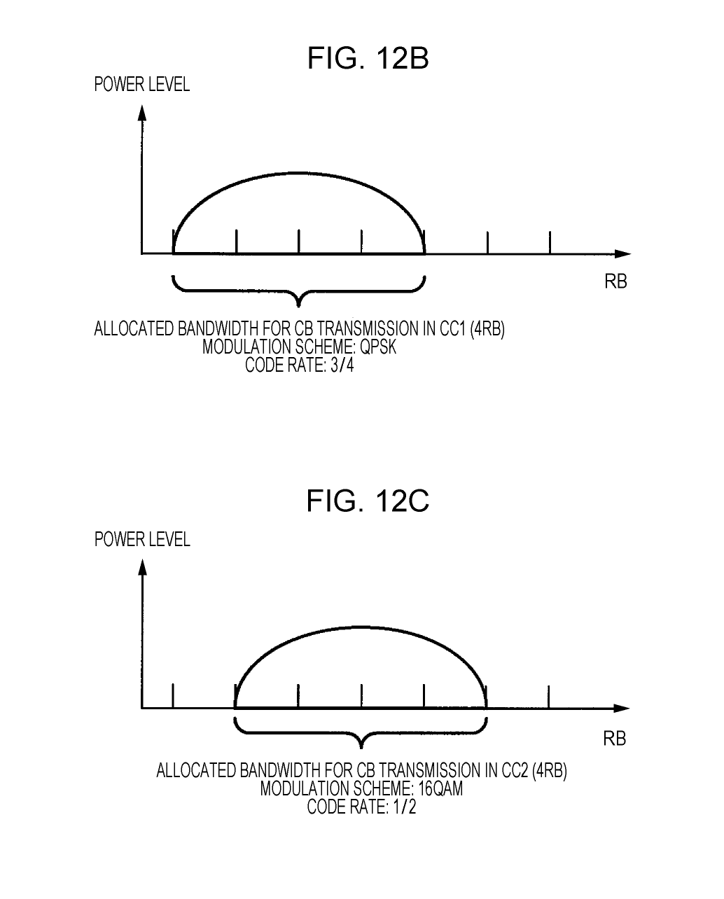

FIG. 12A is a diagram illustrating a case in which the base station device 3 according to the fourth embodiment of the present invention configures a different MCS for each allocated band for CB transmission. In FIG. 12A, a case is illustrated in which the base station device 3 allocates a first allocated band for CB transmission of using RB1 to RB3 and a second allocated band for CB transmission of using RB4 to RB6, when there are six RBs usable in the CB transmission. Here, while the base station device 3 sets a modulation scheme QPSK and a coding rate 3/4 in the case of using the first allocated band for CB transmission, and sets a modulation scheme 16 QAM and a coding rate 1/2 in the case of using the second allocated band for CB transmission, the base station device 3 generates two CB grants for setting different transmission rates and notifies the generated CB grants to the mobile station device 1. The mobile station device 1 extracts two CB grants, and determines whether to use the first allocated band for CB transmission having a low order MCS or the second allocated band for CB transmission having a high order MCS, according to the available capacity of transmission power of the mobile station device 1. For example, the MCS selection reference a_{target}(m) is calculated as a function of the allocated bandwidth m, by Expression (7).

[Math 7]

a_{target}(m)=P_{target}−(P₀+α·PL+10 log₁₀(m)) (7)

P_{target} is reference transmission power in the CB transmission. The mobile station device 1 selects one band having the transmission power to be compensated in the used MCS which is smaller than a_{target} (m), among selectable allocated bands for CB transmission, and uses the selected band for CB transmission. However, in order to improve a transmission rate to be high as possible, the allocated band for CB transmission having a maximum bandwidth in a range of being equal to or less than a_{target}(m) may be selected. Further, even when CA is applied, the same process may be applied.

FIGS. 12B and 12C are diagrams illustrating a case in which the base station device 3 according to the fourth embodiment of the present invention configures a different MCS for each allocated band for CB transmission in each CC. FIGS. 12B and 12C respectively illustrate cases of allocating the allocated bands for CB transmission of four RBs to CC1 and CC2. Here, the base station device 3 allocates the modulation scheme QPSK and the coding rate 3/4 to allocated band for CB transmission in CC1, and allocates the modulation scheme 16 QAM and the coding rate 1/2 to an allocated band for CB transmission in CC2. The base station device 3 notifies the allocated band and MCS for the CB transmission in each CC as a CB grant, to the mobile station device 1. Then, similarly to the case of FIG. 12A, the mobile station device 1 selects the CC of selectable MCS based on the reference of Expression (7), and performs the CB transmission.

Further, although the case of using different bandwidths and a case of using different MCS in a plurality of allocated bands for CB transmission have been independently described, two cases may simultaneously occur. In other words, when two allocated bands for CB transmission are allocated, different bandwidths and a different MCS may be used in the first allocated band for CB transmission and the second allocated band for CB transmission. In this case, Expression (8) is considered as the reference X when the mobile station device 1 selects an allocated band for CB transmission.

[Math 8]

X=P_{target}−(P₀+α·PL) (8)

Here, the mobile station device 1 calculates a necessary compensation value b(m_{c}, a_{c}), based on m_{c} which is a bandwidth used for each CB grant and a_{c} that is used by MCS, in Expression (9).

[Math 9]

b(m_{c},a_{c})=10 log₁₀(m_{c})+Δ_{TF}(a_{c}) (9)

Then, the CB grant used for the CB transmission is selected among CB grants in which the necessary compensation value b(m_{c}, a_{c}) is X or less. However, in order to increase the transmission rate, a maximum b(m_{c}, a_{c}) in a range of being equal to or less than X may be selected.

Hitherto, at the time of performing the CB transmission, the mobile station device 1 may obtain suitable transmission power and a transmission throughput by configuring a different bandwidth or MCS for each selectable CB grant, and by selecting CB grant, based on the transmission power that is set in the mobile station device 1.

### [Aspect in Case of Using Transmit Diversity Scheme]

Next, a case of using a transmit diversity scheme when the mobile station device 1 performing the CB transmission has a plurality of transmit antennas 127 will be described. Here, in the transmit diversity scheme, a plurality of transmit signals configured with the same data is generated by coding the data signal, and a diversity gain is obtained in the base station device 3 by transmitting the generated transmit signals from the respective different antennas. Generally, in the CF transmission, the base station device 3 which is a receiver may recognize the channel status through the signals which are transmitted from the mobile station device 1 which is a transmitter, and thus it is possible to use a transmit diversity scheme called a pre-coding. In the pre-coding, a combination of transmit signals in which the power of signals received in the base station device 3 is increased is notified to the mobile station device 1, and the mobile station device 1 may obtain a high diversity gain by using the notified combination.

However, in the CB transmission, at a time in which the mobile station device 1 starts transmission, the base station device 3 may not recognize the channel status through the signals which are transmitted from the mobile station device 1, and thus it is not possible to obtain a diversity gain due to the pre-coding described above. Thus, in the case of using the CB transmission, the transmit diversity scheme capable of obtaining the diversity gain is used without understanding the channel status. As the transmit diversity scheme, for example, Space Frequency Block Coding (SFBC), Space Time Block Coding (STBC), and the like are known. Accordingly, the mobile station device 1 in the present embodiment uses the transmit diversity scheme of using channel information at the time of performing the CF transmission by transmit diversity, and uses a transmit diversity scheme that does not require channel information at the time of performing the CB transmission by transmit diversity. As a result, the mobile station device 1 may obtain a high diversity gain in each of the CF transmission and the CB transmission.

The program operated in the mobile station device 1 and the base station device 3 according to the present invention is a program (program for causing a computer to function) for controlling a CPU and the like in order to realize the functions of the above embodiments of the present invention. Then, the information handled by the devices is temporarily stored in a RAM at a time of the process, and thereafter, is stored in various ROMs and HDDs, and the reading, modifying, and writing are performed by the CPU, as necessary. A recording medium for storing the program may be any of a semiconductor medium (for example, ROM, nonvolatile memory card, and the like), an optical recording medium (for example, a DVD, a MO, a MD, a CD, a BD, and the like), a magnetic recording medium (for example, a magnetic tape, a floppy disk, and the like).

The function of the embodiment described above is not only realized by executing the loaded program, but also the functions of the present invention are realized in some cases, by processing the loaded program in conjunction with an operating system or other application programs, based on the instructions of the program. When distributed in the market, portable recording media that store the program may be distributed or the program may be transmitted to a server computer that is connected through a network such as the Internet. In this case, the storage device of the server computer is included in the present invention.

Further, the entirety or a portion of the mobile station device 1 and the base station device 3 in the above described embodiment may be typically implemented as an LSI which is an integrated circuit. The respective functional blocks of the mobile station device 1 and the base station device 3 may be individually formed into chips, or all or a part thereof may be integrated and formed into a chip. Further, a circuit integration technology is not limited to an LSI, and may be implemented as a dedicated circuit, or in a general purpose processor. Further, when the circuit integration technology that replaces the LSI appears with the advance of a semiconductor technology, it is possible to use an integrated circuit according to the technology.

Hitherto, the embodiments of the invention have been described in detail with reference to the drawings, but the specific configuration is not limited to the embodiments, and the design and the like is included in the scope of Claims, without departing from the scope of the invention. The present invention is suitable for use in a mobile communication system in which the mobile station device 1 is a mobile telephone device, but is not limited thereto.

### REFERENCE SIGNS LIST

1 MOBILE STATION DEVICE
3 BASE STATION DEVICE
101 RECEIVE ANTENNA
103 MOBILE STATION RADIO RECEPTION UNIT
105 CONTROL INFORMATION EXTRACTION UNIT
107 CLIPPING UNIT
109 CODING UNIT
111 MODULATION UNIT
113 DFT UNIT
114 SPECTRUM GENERATION UNIT
115 REFERENCE SIGNAL GENERATION UNIT
117 REFERENCE SIGNAL MULTIPLEXING UNIT
119 MAPPING UNIT
121 IDFT UNIT
123 CP INSERTION UNIT
125 MOBILE STATION RADIO TRANSMISSION UNIT
127 TRANSMIT ANTENNA
201 RECEIVE ANTENNA
203 BASE STATION RADIO RECEPTION UNIT
205 CP REMOVAL UNIT
207 FIRST DFT UNIT
209 DE-MAPPING UNIT
211 SCHEDULING UNIT
213 CONTROL INFORMATION GENERATION UNIT
215 BASE STATION RADIO TRANSMISSION UNIT
217 TRANSMIT ANTENNA
218 REFERENCE SIGNAL SEPARATION UNIT
219 CHANNEL ESTIMATION UNIT
221 FIRST ZERO INSERTION UNIT
223 SECOND ZERO INSERTION UNIT
225 CHANNEL MULTIPLICATION UNIT
227 SECOND DFT UNIT
229 CANCELLATION UNIT
231 EQUALIZATION UNIT
233 REPLICA GENERATION UNIT
235 DEMODULATION UNIT
237 DECODING UNIT
239 DETERMINATION UNIT
301 SIGNAL DETECTION UNIT
401 TRANSMISSION POWER CONTROL UNIT
403 CONTROL INFORMATION EXTRACTION UNIT

1-12. (canceled)

13. A base station device that performs communication with a communication device, comprising:
a scheduling unit that configures a band for contention based transmission including a plurality of allocated bands which are selectable by the communication device; and
a transmission unit that notifies the communication device of information indicating the configured band for the contention based transmission,
wherein at least one of the plurality of allocated bands is configured to partially overlap another one of the plurality of allocated bands.

14. The base station device according to claim 13,
wherein the plurality of allocated bands included in the band for the contention based transmission are configured such that a ratio of bands overlapping each other is equal to or less than an allowable overlap ratio.

15. The base station device according to claim 14,
wherein the allowable overlap ratio is configured based on an MCS to be applied in the contention based transmission.

16. A communication device that performs communication with a base station device, comprising:
a reception unit that receives a signal from the base station device;
a detection unit that detects information indicating a band for contention based transmission including a plurality of selectable allocated bands, from the signal; and
a transmission unit that selects one allocated band from the plurality of allocated bands based on the detected information indicating the band for the contention based transmission, and transmits a contention based signal,
wherein at least one of the plurality of allocated bands overlaps another one of the plurality of allocated bands in a portion of the band.

17. The communication device according to claim 16, further comprising:
a transmission power control unit that configures transmission power of a signal to be transmitted from the transmission unit,
wherein the detection unit detects information indicating whether to perform the contention based transmission from the signal,
wherein the transmission unit transmits the contention based signal or a contention free signal, based on the information indicating whether to perform the contention based transmission, and
wherein the transmission power control unit configures the transmission power based on different determination equations, in a case of transmitting the contention based signal and in a case of transmitting the contention free signal.

18. The communication device according to claim 17,
wherein the transmission power control unit configures the transmission power, based on a parameter which is notified from the base station device, and the parameter is independently notified for each of the case of transmitting the contention based signal and the case of transmitting the contention free signal.

19. The communication device according to claim 17,
wherein the transmission power control unit configures the transmission power, based on a correction value of a closed loop which is notified from the base station device, and the correction value of a closed loop is independently notified for each of the case of transmitting the contention based signal and the case of transmitting the contention free signal.

20. The communication device according to claim 17,
wherein the transmission power control unit configures the transmission power, using a correction value of a closed loop which is notified from the base station device, in the case of transmitting the contention based signal, and
wherein the transmission power control unit configures the transmission power, without using the correction value of a closed loop which is notified from the base station device, in the case of transmitting the contention free signal.

21. A transmission method used in a communication device that performs communication with a base station device, comprising:
receiving a signal from the base station device;
detecting information indicating a band for contention based transmission including a plurality of selectable allocated bands, from the signal; and
selecting one allocated band from the plurality of allocated bands based on the detected information indicating the band for the contention based transmission, and transmitting a contention based signal,
wherein at least one of the plurality of allocated bands partially overlaps another one of the plurality of allocated bands.
